(19) United States
(12) Patent Application Publication
(10) Pub. No.: US 2026/0119611 A1
(43) Pub. Date: Apr. 30, 2026

(54) Intelligent control method for sewage treatment equipment at dry bulk cargo terminals

(71) Applicant: TIANJIN RESEARCH INSTITUTE FOR WATER TRANSPORT ENGINEERING.M.O.T, Tianjin (CN)

(72) Inventors: Jianna Jia, Tianjin (CN); Shitao Peng, Tianjin (CN); Kailei Zhang, Tianjin (CN); Liankun Liu, Tianjin (CN); Ning Qiu, Tianjin (CN); Peng Zheng, Tianjin (CN); Guoqiang Ma, Tianjin (CN); Baocui Liang, Tianjin (CN)

(73) Assignee: TIANJIN RESEARCH INSTITUTE FOR WATER TRANSPORT ENGINEERING.M.O.T, Tianjin (CN)

(21) Appl. No.: 19/160,263

(22) PCT Filed: Jun. 18, 2025
(86) PCT No.: PCT/CN2025/101678

§ 371 Date: Aug. 27, 2025

(30) Foreign Application Priority Data
Jun. 27, 2024 (CN) 202410841119.5

(51) Int. Cl. G06F 18/2411; C02F 1/00; G06F 18/213

(52) U.S. Cl. CPC G06F 18/2411; C02F 1/008; G06F 18/213

(57) ABSTRACT

The present invention discloses an intelligent control method for sewage treatment equipment at dry bulk cargo terminals, relating to the technical field of sewage treatment equipment control, and is used to address the problem of poor control of sewage treatment equipment at terminals. The method comprises following steps: installing multiple types of sensors at key locations on dry bulk cargo terminals, utilizing edge computing nodes for real-time data acquisition and preprocessing, combining historical and temporal features with machine learning models to classify sewage types, achieving efficient dynamic adjustment of sewage treatment equipment operation parameters, then using weighted voting and confidence assessment to integrate multiple classification results to ensure optimal treatment results, and analyzing the actual sewage treatment situation to optimize equipment control continuously, thereby preventing failures, extending equipment life, and improving sewage treatment effectiveness.

### TECHNICAL FIELD

The present invention relates to the technical field of sewage treatment equipment control, and in particular to an intelligent control method for sewage treatment equipment at dry bulk cargo terminals.

### BACKGROUND TECHNOLOGY

Dry bulk terminals are usually equipped with large-scale loading and unloading equipment, such as belt conveyors, grab cranes, loaders, etc., to facilitate efficient loading, unloading and handling of goods. In addition, these terminals will also have corresponding storage facilities, such as yards and silos, to meet the needs of temporary storage and transshipment of goods. Especially in the import and export of mineral resources and agricultural commodities, through dry bulk terminals, goods can be efficiently transported from the production site to the consumption site, ensuring the smooth and stable supply chain.

The existing technology has the following shortcomings: in the loading and unloading areas of dry bulk cargo terminals, flushing is often required. The flushing water will carry away the mud, oil and bulk materials (such as ore dust, grain residues, etc.) on the ground, forming sewage. Ships docked at the terminal may also generate sewage, including domestic sewage (such as domestic sewage of crew members), oily sewage in the engine room and cargo hold cleaning wastewater, etc., and the existing dry bulk cargo terminal sewage treatment equipment has problems such as incomplete data collection, insufficiently intelligent control strategies, insufficient fault prediction and prevention, and low energy consumption and resource utilization. These shortcomings make it impossible to monitor and record sewage-related data in real time, making it difficult for the sewage treatment control system to adapt to complex and changing needs, resulting in increased equipment maintenance costs and low operation efficiency.

The above information disclosed in this background technology is only for enhancement of understanding of the background of the present disclosure and therefore it may contain information that does not form the prior art that is already known to a person of ordinary skill in the art.

### SUMMARY OF THE INVENTION

The purpose of the present invention is to provide an intelligent control method for sewage treatment equipment at dry bulk cargo terminals. The present invention installs multiple types of sensors at key locations of the dry bulk cargo terminals, utilizes edge computing nodes for real-time data acquisition and preprocessing, combines historical characteristics and time characteristics, uses machine learning models to classify sewage types, thereby achieving efficient dynamic adjustment of sewage treatment equipment operation parameters, utilizes weighted voting and confidence evaluation to integrate multiple classification results to ensure the best treatment effect, thereby addressing the shortcomings of the background technology.

To achieve above-mentioned objectives, the present invention provides following technical solutions: an intelligent control method for sewage treatment equipment at dry bulk cargo terminals comprises following steps:
various types of sensors are installed at different locations at dry bulk terminals to collect sewage data in real time, preliminary data preprocessing and analysis are performed to obtain initial classifications of sewage types;
historical features and temporal features are extracted from historical data, and the historical and temporal features extracted are combined with preprocessed data to form complete feature vectors for machine learning model input;
models classify based on feature vectors input, output predictive probabilities or classification labels for the sewage types, combining results of rule-based classification and machine learning classification, weighted voting is combined with confidence assessment, so as to obtain final classification results, and operation parameters of sewage treatment equipment are dynamically adjusted based on the final classification results; and
operation and processing information generated after adjusting the operation parameters of the sewage treatment equipment is obtained, sewage treatment status is determined after adjusting the operation parameters according to the final classification results, and controlling the sewage treatment equipment is adjusted and optimized based on treatment results obtained.

Preferably, the steps that preliminary data preprocessing and analysis are performed to obtain initial classifications of sewage types comprise:
connecting sensors to edge computing nodes, setting data collection frequency and format through the edge computing nodes, and using mean filtering to remove noise from data;
standardizing and converting the data to convert to a uniform unit and scale;
determining preset water quality parameter thresholds based on real-time collected sewage quality parameters, and using the preset water quality parameter thresholds as classification criteria; and
performing preliminary classification based on the preset water quality parameter thresholds, iterating through each of the data samples collected, comparing each water quality parameter against the preset water quality parameter thresholds, performing preliminary classification based on comparison results, and marking classification results for each of the data samples.

Preferably, the steps that historical features and temporal features are extracted from historical data, and the historical and temporal features extracted are combined with preprocessed data to form complete feature vectors for machine learning model input, specifically comprise:
extracting data based on temporal features to determine changes in sewage characteristics over different time periods, adding time tags to each of the data samples, and dividing the data into different time periods based on time of collection;
calculating moving average values and moving standard deviations within time windows of the historical data, and extracting historical features based on calculation results; and
after extracting and constructing the temporal features and the historical features, combining preprocessed real-time data with extracted temporal features and historical features, and incorporating for being input into models, wherein
the models comprise random forests, support vector machines, and neural networks.

Preferably, the steps that combining results of rule-based classification and machine learning classification, weighted voting is combined with confidence assessment, so as to obtain final classification results, specifically comprise:
according to preset water quality parameter thresholds, performing rule-based classification on the data samples, and assigning one or more sewage types to each of the data samples based on the rule-based classification;
for each of the data samples, performing weighted voting on classification results of machine learning models and results of the rule-based classification, assigning different weights to each classification method based on accuracy thereof;
using the machine learning models to classify the data samples, assessing confidence coefficients of categories based on the rule-based classification, and obtaining an overall confidence coefficient for the categories; and
according to a method of weighted voting combined with confidence assessment, determining final sewage types for each of the data samples, and outputting final classification results for each of the data samples.

Preferably, the steps that operation and processing information generated after adjusting the operation parameters of the sewage treatment equipment is obtained, sewage treatment status is determined after adjusting the operation parameters according to the final classification results, specifically comprise:
obtaining operation and processing information generated after adjusting the operation parameters of the sewage treatment equipment, wherein the operation and processing information comprises equipment operation information and sedimentation impact information;
the equipment operation information comprises an operation equipment response stability index, and the sedimentation impact information comprises a multi-dimensional sedimentation deviation index;
the operation equipment response stability index and the multi-dimensional sedimentation deviation index are combined to generate an equipment control coefficient; and
the operation equipment response stability index is inversely proportional to the equipment control coefficient, while the multi-dimensional sedimentation deviation index is directly proportional to the equipment control coefficient.

Preferably, the step that controlling the sewage treatment equipment is adjusted and optimized based on treatment results obtained specifically comprises:
comparing the generated device control coefficient with an intelligent control threshold;
generating a sewage treatment abnormality signal and adjusting a sewage treatment control plan if the device control coefficient exceeds the intelligent control threshold; and
generating a sewage treatment stable signal and eliminating the need for sewage treatment control and continuing monitoring and maintenance if the device control coefficient is less than or equal to the intelligent control threshold.

In the above-mentioned technical solutions, the present invention provides following technical effects and advantages:

The present invention installs multiple types of sensors at key locations on dry bulk cargo terminals and utilizes edge computing nodes for real-time data collection and preprocessing, combines historical and temporal features, uses machine learning models to classify wastewater types to achieve efficient dynamic adjustment of wastewater treatment equipment operation parameters, utilizes voting and confidence assessment to integrate multiple classification results to ensure optimal treatment results, and analyze actual wastewater treatment conditions to optimize equipment control continuously, thereby preventing failures, extending equipment life, and improving wastewater treatment effectiveness.

The intelligent control method for wastewater treatment equipment in the present invention significantly improves wastewater treatment efficiency and effectiveness, reduces operation costs, and enhances equipment operation stability and reliability. Through intelligent monitoring, data analysis, and dynamic adjustment, the present invention achieves efficient, stable, and intelligent management of wastewater treatment; ensuring effluent quality meets standards and protecting the environment.

### BRIEF DESCRIPTION OF THE DRAWINGS

In order to more clearly illustrate the embodiments of the present invention or the technical solutions in the prior art, a brief introduction to drawings required for use in the embodiments will be given below. Obviously, the drawings described below are only some embodiments recorded in the present invention. For ordinary technicians in this field, other drawings can also be obtained based on these drawings.

FIG. 1 is a flow chart of an intelligent control method for dry bulk cargo terminal sewage treatment equipment according to the present invention.

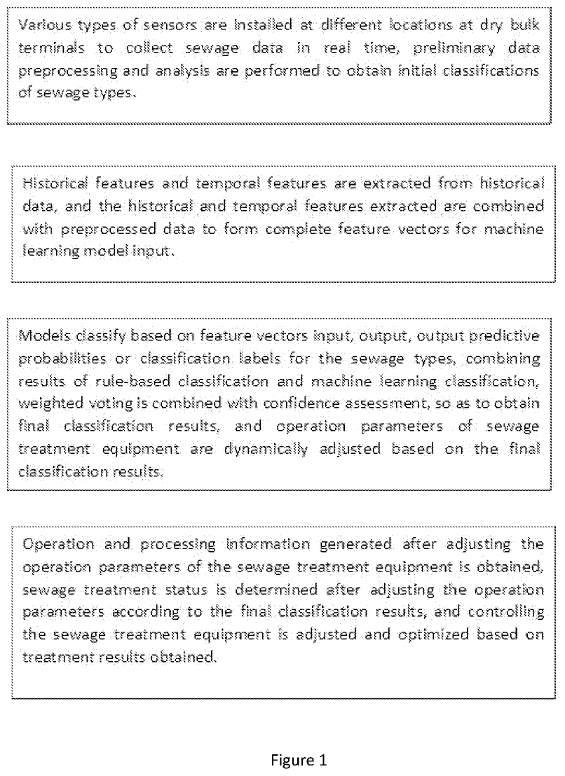

### SPECIFIC EMBODIMENTS

Now, the exemplary embodiments will be described more comprehensively with reference to the accompanying FIGURES. However, the exemplary embodiments can be implemented in various forms and should not be construed as limited to the examples presented here; rather, the provision of these exemplary embodiments makes the description of this disclosure more comprehensive and complete, effectively conveying the concepts of the exemplary embodiments to those skilled in the art.

### Embodiment 1

The present invention provides an intelligent control method for sewage treatment equipment at dry bulk cargo terminals comprising following steps:
various types of sensors are installed at different locations at dry bulk terminals to collect sewage data in real time, preliminary data preprocessing and analysis are performed to obtain initial classifications of sewage types;
historical features and temporal features are extracted from historical data, and the historical and temporal features extracted are combined with preprocessed data to form complete feature vectors for machine learning model input;
models classify based on feature vectors input, output predictive probabilities or classification labels for the sewage types, combining results of rule-based classification and machine learning classification, weighted voting is combined with confidence assessment, so as to obtain final classification results, and operation parameters of sewage treatment equipment are dynamically adjusted based on the final classification results; and
operation and processing information generated after adjusting the operation parameters of the sewage treatment equipment is obtained, sewage treatment status is determined after adjusting the operation parameters according to the final classification results, and controlling the sewage treatment equipment is adjusted and optimized based on treatment results obtained.

Key locations at terminals are selected for monitoring, including water inlets, water outlets, treatment tanks, rainwater collection areas, flushing areas, machinery cleaning areas, and ship sewage discharge outlets. Multiple types of sensors are installed at different locations in the dry bulk terminals to collect comprehensive sewage data. Sensors comprise water quality monitoring sensors for monitoring pH value, dissolved oxygen, chemical oxygen demand (COD), biological oxygen demand (BOD), suspended solids concentration, heavy metal content, etc. Water quality monitoring sensors are installed at water inlets, water outlets, treatment tanks, rainwater collection areas, flushing areas, etc.

Flow sensors measure sewage flow and are installed at the inlets and outlets of major drainage pipes. Temperature sensors monitor sewage temperature and are installed at key points such as water inlets and treatment pools. Oil pollution monitoring sensors monitor oil pollution content and are installed in mechanical cleaning areas, ship sewage discharge outlets, etc.

These sensors are connected to edge computing nodes to ensure that data can be transmitted to edge computing devices in real time. IoT technologies such as LoRa and NB-IoT are used to transmit sensor data to the cloud in real time, store and manage sensor data in the cloud, and ensure data security and accessibility.

Edge computing nodes are installed at each monitoring point to perform preliminary data processing and analysis. The edge computing nodes process sensor data in real time, perform preprocessing (such as denoising and standardization), and classify sewage types according to preset rules. The specific steps are as follows:
on the edge computing nodes, data reception is configured to receive real-time sensor data, the data collection frequency and format are set, and a mean filter algorithm is applied to denoise and remove noise from the sensor data to ensure data accuracy; meanwhile, the data is normalized to convert it to a unified unit and scale;
mean filtering is achieved by selecting a window size k and calculating the average value of each data point in the window to replace the original data point, for the data sequence, x₁, x₂, . . . , xₙ, the calculation formula for the mean filtered data yᵢ is:

$${y}_{i} = \frac{1}{k} {\sum }_{j = 1 - \frac{k - 1}{2}}^{i + \frac{k - 1}{2}} {x}_{j} ,$$

where k represents window size and value range of i is (k+1)/2 to n−(k−1)/2;
the data is standardized by using Min-Max standardization, for the data sequence, the formula for the standardized data x₁ is:

$${x}_{i}^{′} = \frac{{x}_{i} - min ( x )}{max ( x ) - min ( x )} ,$$

where min represents the minimum value of the sequence and max represents the maximum value of the sequence;
rule-based classification: preliminary classification is performed according to preset water quality parameter thresholds, the collected data is divided into multiple data samples, based on various water quality parameters of sewage collected in real time, such as pH value, COD concentration, dissolved oxygen (DO), etc., the water quality parameter thresholds are determined, for example, pH<6 is preliminarily classified as strongly acidic sewage, pH>9 is preliminarily classified as strongly alkaline sewage, COD concentration threshold COD>200 mg/L is preliminarily classified as highly organically polluted sewage, and DO<2 mg/L is preliminarily classified as low dissolved oxygen sewage;
based on the various water quality parameters collected in real time, preset water quality parameter thresholds are determined and used as classification criteria;
each of the data samples collected is traversed to check whether its various water quality parameters meet the classification criteria, each water quality parameter of each of the data samples is compared with the water quality parameter thresholds, based on the preset classification criteria, each of the data samples is checked for various water quality parameters, and a preliminary classification is performed; the classification results for each of the data samples are then marked, ensuring that the sewage treatment equipment can adopt the optimal treatment plan for each type of sewage; and
through the above specific steps, the sewage from the dry bulk terminals can be effectively classified according to the preset water quality parameter thresholds, ensuring that the sewage treatment equipment can adopt the optimal treatment plan for each type of sewage, thereby improving sewage treatment efficiency and effectiveness.
temporal features (e.g., daytime, nighttime) and historical features (using moving average, moving standard deviation, etc.) are extracted from historical data (historical sewage-related data from dry bulk terminals) to enhance data features, and preprocessed data is input into trained machine learning models (e.g., random forest, support vector machine, neural network, etc.) for real-time classification, which comprise specific steps as follows:
extract data based on temporal features and define time periods, dividing a day into different time periods (such as daytime, nighttime, morning, and evening) to determine how sewage characteristics vary over time, wherein time period divisions can be based on practical experience and data analysis results, for example, daytime can be 6:00 AM to 6:00 PM, and nighttime can be 6:00 PM to 6:00 PM;
add time tags to each of the data samples and divide it into different time periods based on the time of collection; and
extract historical features from historical data and calculate moving averages within time windows to reflect short-term trends in sewage parameters, such as the moving average of pH over a 5-minute window, and also calculate the moving standard deviation within a time window to reflect the volatility of sewage parameters, such as the moving standard deviation of pH over a 5-minute window, and calculate historical maximum and minimum values within a specific time window to reflect extreme fluctuations in parameters.

After extracting and constructing temporal and historical features, the preprocessed real-time data is combined with the extracted temporal and historical features to form a complete feature vector for model input.

Feature selection algorithms such as recursive feature elimination and principal component analysis are used to screen for the most influential features for classification, reducing feature redundancy and improving model efficiency.

Principal component analysis (PCA) projects the data into a low-dimensional space through a linear transformation to extract the principal components that best explain the data variance:
calculate the data covariance matrix, then calculate the eigenvalues and eigenvectors of the covariance matrix, select the eigenvectors corresponding to the top k largest eigenvalues to form the eigenvector matrix W;
project the data into the low-dimensional space: Z=XW, where Z is the principal component matrix, X is the original data matrix, and W is the eigenvector matrix;
partition the dataset into training sets and test sets, typically using an 80% training set and a 20% test set ratio, use cross-validation methods (such as k-fold cross-validation) to further partition the training set to assess model stability and generalization;
divide the training sets into k subsets, each time, train the models with k−1 subsets and test with the remaining one subset, repeat k times, and calculate average performance metric, and a k-fold cross-validation formula is:

$$CV = \frac{1}{k} {\sum }_{i = 1}^{k} {M}_{i} ,$$

where Mᵢ is the performance metric of the i-th validation;
choose an appropriate machine learning model based on your specific needs, such as random forests, support vector machines (SVMs), or neural networks, wherein random forests are suitable for processing multi-feature data and have strong generalization and robustness; support vector machines (SVMs) are suitable for classifying high-dimensional data and can find the optimal classification hyperplane; and neural networks are suitable for modeling complex data relationships and can automatically extract features;
use the training set data to train selected models, and adjust model parameters (such as the number of trees in the random forests, the kernel function type in the SVM, and the number of layers and neurons in the neural network) to optimize model performance;
use methods such as grid search or random search to optimize the models' hyperparameters, for example, the hyperparameters of the random forest comprise number of trees and the maximum tree depth;
perform K-fold cross-validation to evaluate the models' performance under different data partitions to ensure model stability and generalization ability;
use metrics such as accuracy, precision, recall, and F1 score to evaluate model performance, wherein accuracy is the proportion of data samples correctly predicted by the model out of the total data samples; precision is the proportion of data samples predicted as positive by the model that are actually positive; recall is the proportion of data samples predicted as positive by the model that are actually positive; and F1 score is the harmonic mean of precision and recall; and
use the test set data to evaluate trained models, calculate various evaluation metrics to ensure model generalization ability and stability.

The models classify the input features and output predicted probabilities or class labels for each wastewater type. For example, the models might predict a data sample as “highly organically contaminated water” or “strongly acidic/alkaline wastewater.”

The final classification results are derived by combining the rule-based and machine learning classification results, and using weighted voting and confidence assessment. Based on this final classification results, the operation parameters of the wastewater treatment equipment are dynamically adjusted to ensure optimal treatment results.

Rule-based classification is performed based on preset water quality parameter thresholds. For example, if the pH value is less than 6 or greater than 9, the initial classification is “strongly acidic/strongly alkaline wastewater.” Similarly, if the COD value exceeds a certain threshold (e.g., 200 mg/L), the initial classification is “highly organically contaminated water.”

For each of the data samples, one or more possible wastewater types are determined based on the rule-based classification.

For each of the data samples, a weighted vote is performed on the classification results from the machine learning model and the rule-based classification results.

Each classification method can be assigned different weights based on its accuracy or reliability. For example, a higher weight can be assigned to a machine learning model with higher accuracy.

The specific steps of the weighted voting mechanism are as follows: use a machine learning model (such as random forest, support vector machine, or neural network) to classify the data and obtain the predicted probability for each category;
perform a rule-based classification on the data based on preset water quality parameter thresholds to obtain a vote for each category (1 or 0);
determine the weights of the machine learning model and the rule-based classification, assigning weights based on their respective accuracy and reliability, assume that the weight of the machine learning model is w_{model} and the weight of the rule-based classification is wᵣᵤₗₑᵣ;
for result of each category, conduct weighted voting, combine the prediction probabilities of the machine learning model with the votes from the rule-based classification as follows:

$$FC = arg {max}_{C ∈ LB} ( {w}_{model} * {p}_{model} ( c ) + {w}_{ruler} * {p}_{ruler} ( c ) ) ,$$

where argmax represents the input value corresponding to the maximum value. LB represents the category types, c represents the category (such as strong acidic/strongly alkaline wastewater, high organic pollution water, etc.), p_{model}(c) is the probability that the machine learning model predicts category c, pᵣᵤₗₑᵣ(c) is the vote of the rule-based classification for category c (1 or 0), w_{model} is the weight of the machine learning model, wᵣᵤₗₑᵣ is the weight of the rule-based classification.

If the machine learning model provides a probability distribution for the classification, these probabilities can be used as confidence indicators. The final classification result can be comprehensively judged based on the confidence coefficient of the machine learning model and the rule-based classification.

Use the machine learning models to classify the data to obtain the confidence coefficient (probability) of each category, wherein the confidence coefficient assessment of each category based on the rule classification can be set to a fixed value or dynamically adjusted based on historical accuracy;
integrate the confidence levels of each category and calculate the total confidence level of each category, wherein the calculation formula is:

$$FC = arg {max}_{C ∈ LB} ( {C}_{model} ( c ) + {V}_{ruler} ( c ) ) ,$$

where C_{model}(c) represents the confidence coefficient of the machine learning model for classification c, and Cᵣᵤₗₑᵣ(c) represents the confidence coefficient of the rule-based classification for classification c;
use weighted voting combined with a confidence assessment method to determine the final wastewater type of each of the data samples, and output the final classification result for each of the data samples for further wastewater treatment equipment control decisions;

For example, the machine learning model predicts that a data sample is classified as “strongly acidic/alkaline wastewater” with a probability of 0.7 and “highly organically contaminated water” with a probability of 0.3;
based on the rule-based classification, the data sample is classified as “strongly acidic/alkaline wastewater” (vote 1) and not classified as “highly organically contaminated water” (vote 0), assume the machine learning model weight is 0.7 and the rule-based classification weight is 0.3,
for “strongly acidic/alkaline wastewater”: 0.7×0.7+0.3×1=0.49+0.3=0.79, and for “highly organically contaminated water”: 0.7×0.3+0.3×0=0.21;
classify the data samples, and obtain that the final classification result was “strongly acidic/strongly Alkaline wastewater”;
for “strongly acidic/strongly alkaline wastewater”: the confidence coefficient of the machine learning model was 0.7, the confidence coefficient of the rule-based classification was 0.5, and the overall confidence coefficient was 0.7+0.5=1.20; for “highly organically contaminated water”: the confidence coefficient of the machine learning model was 0.3, the confidence coefficient of the rule-based classification was 0.2, and the overall confidence coefficient was 0.3+0.2=0.5, resulting in the final classification result being “strongly acidic/strongly alkaline wastewater”;
through a combined weighted voting and confidence assessment method, the final classification results for the wastewater data samples were obtained, and the classification results were used to guide the adjustment of operation parameters of the wastewater treatment equipment to ensure optimal treatment results.

Operation and processing information generated after adjusting the operation parameters of the sewage treatment equipment is obtained, the sewage treatment status after adjusting the equipment operation parameters based on the final classification results is determined, based on the resulting processing results, adjustments and optimization of sewage equipment control are performed. The operation processing information comprises equipment operation information and sedimentation impact information;
the equipment operation information comprises an operation equipment response stability index, and the sedimentation impact information comprises a multi-dimensional sedimentation deviation index, after collection, the operation equipment response stability index and the multi-dimensional sedimentation deviation index are calibrated as YXS and DWC, respectively.

The operation equipment response stability index is a comprehensive index used to assess the stability and reliability of sewage treatment equipment during the treatment process, which reflects whether the equipment can adjust stably and efficiently to sewage changes and maintain stable treatment results; by monitoring equipment adjustment time, operation parameter fluctuations, and failure frequency, and analyzing the results, it can help identify and resolve equipment operation issues, optimize treatment strategies, improve equipment reliability and efficiency, and ensure stable treatment results.

The operation equipment response stability index has following benefits:
improving equipment reliability: by continuously monitoring equipment adjustment times, operation parameter fluctuations, and failure frequency, potential operation issues can be promptly identified, signs of unstable equipment response can be identified in advance, equipment failures can be prevented, unplanned downtime can be reduced, and resources can be focused on maintenance of unstable equipment, thereby improving equipment reliability;
optimizing treatment strategies: through feedback from the operation equipment response stability index, equipment operation parameters (such as aeration time, chemical dosage, and agitation speed) can be dynamically adjusted to optimize wastewater treatment plans, equipment responses to changes in wastewater are assessed and improved, thereby ensuring that treatment plans can adapt promptly to changing wastewater characteristics and improving treatment efficiency; and
reducing operation costs: by improving equipment stability and reliability, the cost of frequent repairs and component replacement can be reduced, optimizing equipment operation parameters and treatment strategies can improve treatment efficiency, reduce energy and chemical consumption, and save operation costs.

For example, a certain aeration system experienced significant fluctuations in its adjustment time when treating high-organic-load wastewater. Preemptive maintenance based on the operation equipment response stability index avoided downtime caused by equipment failure. The aeration time and chemical dosage were then adjusted to optimize treatment results and ensure consistent effluent quality. logic for obtaining the operation equipment response stability index is as follows:
installing sensors and monitoring equipment to monitor equipment adjustment time, operation parameters, and fault occurrences in real time, recording start time and end time of each adjustment operation to obtain adjustment time data, regularly recording datasets of equipment operation, including adjustment time, operation parameters, fault occurrence time, and frequencies, to obtain actual adjustment time Adj_{act} and expected adjustment time Adjₑₓₚ, then calculating standard deviations and means of adjustment time, and calculate adjustment time deviation via following formula:

$$ATD = \vert \frac{{Adj}_{act} - {Adj}_{exp}}{{Adj}_{exp}} \vert ;$$

extracting time points and magnitudes ΔParam when parameters change from the datasets, recording time points when parameters reach a stable state t_{stable} and time points when the parameter changes, t_{change}, calculating response time when parameters change

$$PRT = \frac{{t}_{stable} - {t}_{change}}{Δ Param} ,$$

obtaining number of equipment failures F within a time period and total operation time T within the time period;
obtaining standard deviation σ_{Adj} and average value μ_{Adj} of adjustment time, calculating stable value of the adjustment time via following calculation expression:

$$ATS = 1 - \frac{{σ}_{Adj}}{{μ}_{Adj}} ,$$

obtaining standard deviation σ_{Par} and average valueμ_{Par} of operation parameter deviation, calculating fluctuation value of the operation parameters via following expression:

$$PDS = 1 - \frac{{σ}_{Par}}{{μ}_{Par}} ,$$

and calculating the operation equipment response stability index via following expression:

$$YXS = ATS * PDS * ( 1 - \frac{F}{T} ) * ATD * PRT .$$

It should be noted that the amplitude of parameter change refers to the difference between the initial value and the adjusted stable value. The initial and stable values of the parameters are extracted from the data, and the absolute value of the difference between the two is used as the amplitude of parameter change. The number of equipment failures and total operation time within a time period are analyzed statistically within a specified time period, with the specific time range determined based on actual needs.

The multi-dimensional sedimentation deviation index (MSDI) is used to indicate the deviation in sewage settling performance during the sewage treatment process. By comprehensively evaluating the deviations of key parameters in the sedimentation process, the MDI reflects the overall performance, deviations, and instabilities of the sedimentation process. This helps identify and quantify sedimentation problems, optimize treatment processes, and improve the overall effectiveness and efficiency of sewage treatment. The multi-dimensional sedimentation deviation index (MDDI) impacts the following aspects:
wastewater treatment efficiency: by monitoring and optimizing the MDDI, deviations in the sedimentation process can be promptly identified and corrected, thereby improving solid-liquid separation efficiency and ensuring consistent effluent quality; by optimizing the sedimentation process, unnecessary energy and chemical consumption can be reduced, improving resource utilization efficiency; and
environmental impact: by optimizing the sedimentation process, pollutant removal efficiency is increased, pollutant emissions are reduced, and the environment is protected, thereby improving effluent quality and allowing for wider reuse of treated wastewater and conserves water resources.

Logic for obtaining the multi-dimensional sedimentation deviation index is as follows:
obtaining total suspended solids contents TS, volumes of settled sludge|TJ, and interface sedimentation velocities SD in sewage in data samples, obtaining an ideal total suspended solids concentration value TSᵣₑ, an ideal sludge volume index value TJᵣₑ, and an ideal interface sedimentation velocity value SDᵣₑ, calculating a total suspended solids deviation value via following expression:

$${TS}_{dev} = \frac{TS - {TS}_{re}}{{TS}_{re}} ,$$

establishing a total suspended solids deviation value set

$${TS}_{re}^{i} ,$$

a sludge volume index value set TJᵣₑ, and an interface sedimentation velocity value set

$${SD}_{re}^{i} ,$$

performing standardization processing, and obtaining a total suspended solids deviation standard value via following expression:

$$TSP = \frac{1}{n} * \frac{\sum {TS}_{re}^{i} - min ( {TS}_{re}^{i} )}{max ( {TS}_{re}^{i} ) - min ( {TS}_{re}^{i} )} ,$$

where n represents a total number of the data samples, max represents a function for finding a maximum value, and min represents a function for finding a minimum value; similarly, calculating a sludge volume index standard value TJP and an interface sedimentation velocity standard value SDP, and calculating a multi-dimensional sedimentation deviation index via following expression: DWC=\sqrt{TSP²+TJP²+SDP²}.

It should be noted that total suspended solids reflect the content of solid particulate matter in sewage. The total suspended solids can be obtained by obtaining a certain amount of sewage samples from the sewage treatment facility, filtering, drying and weighing them, and calculating the weight difference before and after drying and the volume ratio of the sewage sample to obtain the total suspended solids content; obtain sludge samples from the sedimentation tank or aeration tank in the sewage treatment facility, pour the sludge sample into a measuring cylinder, let it stand for 30 minutes, and measure the volume of the sludge after sedimentation; the interfacial sedimentation velocity reflects the sinking rate of the solid-liquid interface during the sedimentation process, which refers to the sedimentation rate of the sludge suspension interface per unit time.

The obtained running equipment response stability index and multi-dimensional settlement deviation index are normalized and calculated to generate the equipment control coefficient. The equipment control coefficient Sₓ is calibrated according to the following formula:

$${S}_{x} = \frac{β + γ + 1}{γ * YXS} + log ( β * DWC + 1 )$$

where, γ and β are the preset proportional coefficients of the running equipment response stability index and multi-dimensional settlement deviation index, γ and β are greater than 0.

It should be noted that the formula is obtained by technicians in this field by collecting multiple groups of data sample data and setting corresponding preset proportional coefficients for each group of data sample data. The specific calculation process is: substituting the obtained operation equipment response stability index and multidimensional settlement deviation index into the formula to form an equation group, and then screening the calculated preset proportional coefficients and taking the average to obtain the preset proportional coefficients. Since each group of data sample data is different, the specific values of the preset proportional coefficients under different data sample data are also different.

The formula shows that a smaller equipment response stability index and a larger multi-dimensional sedimentation deviation index (i.e., a larger equipment control coefficient) indicate unstable equipment response during operation, untimely adjustments, large fluctuations in operation parameters, and significant deviations in the sedimentation process. This indicates a significant discrepancy between the actual treatment effect and the expected target value. Immediate optimization of equipment operation parameters and process conditions is necessary to improve equipment response stability and sedimentation treatment effectiveness, ensuring effluent quality meets standards.

A larger equipment response stability index and a smaller multi-dimensional sedimentation deviation index (i.e., a smaller performance value of the equipment control coefficient) indicate that the equipment demonstrates high stability and reliability in responding to changes in wastewater characteristics, with rapid and accurate adjustments and minimal fluctuations in operation parameters. This indicates a very stable equipment response, timely adjustments, minimal deviations in the sedimentation process, excellent treatment results, healthy operation conditions, and high resource and energy efficiency. Continuing to maintain and optimize existing strategies will ensure the continued efficiency and stability of the wastewater treatment process.

The generated equipment control coefficient is compared with the intelligent control threshold, and different signals are generated based on the comparison results: a sewage treatment stability signal and a sewage treatment anomaly signal.

After obtaining the generated equipment control coefficient, it is compared with the intelligent control threshold. If the equipment control coefficient is greater than the intelligent control threshold, a sewage treatment anomaly signal is generated, indicating that the sewage treatment process is operation abnormally, prompting the need to immediately optimize equipment operation parameters and process conditions to improve equipment response stability and sedimentation treatment effectiveness, ensuring that effluent quality meets standards. This mechanism can help promptly identify and resolve operation issues, ensuring the efficiency and stability of the sewage treatment process.

If the equipment control coefficient is less than or equal to the intelligent control threshold, a sewage treatment stability signal is generated, indicating that the sewage treatment equipment is responding stably, achieving ideal treatment results, operation in good condition, and meeting effluent quality standards. In this case, the sewage treatment system is operation normally and no emergency adjustments are required. However, continued monitoring and maintenance are required to ensure continued efficient operation.

When a sewage treatment abnormality signal is generated, it indicates that the sewage treatment equipment's process is operation abnormally. Immediately implement the following specific measures to optimize equipment operation parameters and process conditions:

Analyze the sewage treated during the time period when the sewage treatment abnormality signal was generated. Based on the specific time and duration of the sewage treatment abnormality signal, plot a time trend chart of key parameters during the abnormality signal period. Observe the changes in each parameter, perform correlation analysis, calculate the correlations between key parameters, identify which parameter changes may have caused the abnormality signal, and compare the data during the abnormality signal period with the data during normal operation to identify the abnormal points during the abnormality signal period. Analyze the time series data before and after the abnormality signal is generated to identify possible triggering events or conditions. Analyze the equipment's operation status during the abnormality signal period and check whether the equipment has any abnormalities. In the event of a malfunction or abnormal operation, check whether process parameter settings are appropriate and whether adjustments and optimizations are necessary.

Based on the analysis results, optimize operation parameters such as aeration volume, chemical dosage, settling time, and sludge return flow. Specific measures comprise adjusting aeration equipment operation parameters, optimizing aeration volume and time to ensure microbial activity, optimizing chemical dosing, and adjusting chemical dosage and type to ensure optimal treatment results. Sludge return flow is monitored and adjusted. Based on sludge concentration and settling performance, the sludge return flow rate is adjusted to ensure appropriate sludge loading, and the sludge return ratio is optimized to prevent excessive or insufficient sludge loading from impacting treatment results.

Based on wastewater characteristics and treatment results, optimize process flows to improve treatment efficiency. Equipment with problems is maintained and upgraded to ensure normal operation. Real-time monitoring and early warning systems are strengthened to promptly identify and address potential issues.

A detailed analysis of wastewater conditions during the period when abnormal wastewater treatment signals occur can identify the cause of the abnormal signals and formulate corresponding improvement measures. Equipment operation parameters and process conditions are optimized to ensure efficient and stable wastewater treatment and meet effluent quality standards.

It should be noted that the threshold information in the present embodiment is pre-set by professionals and will not be further explained here.

The present invention installs multiple types of sensors at key locations on dry bulk cargo terminals and utilizes edge computing nodes for real-time data collection and preprocessing. Combining historical and temporal features, the present invention uses a machine learning model to classify wastewater types, enabling efficient dynamic adjustment of wastewater treatment equipment operation parameters. Weighted voting and confidence assessment are then used to integrate the various classification results to ensure optimal treatment results. Furthermore, by analyzing actual wastewater treatment conditions, equipment control is continuously optimized to prevent failures, extend equipment life, and enhance wastewater treatment effectiveness.

The intelligent control method for wastewater treatment equipment significantly improves wastewater treatment efficiency and effectiveness, reduces operation costs, and enhances equipment operation stability and reliability. Through intelligent monitoring, data analysis, and dynamic adjustment, it achieves efficient, stable, and intelligent management of wastewater treatment; ensuring effluent quality meets standards and protecting the environment.

The above formulas are all dimensionless and numerically calculated. They are derived from software simulations of a large amount of data collected to obtain the most recent real-world situation. The preset parameters in the formulas are set by those skilled in the art based on actual conditions.

The above descriptions describe only certain exemplary embodiments of the present invention by way of illustration. It is undeniable that those skilled in the art can modify the described embodiments in various ways without departing from the spirit and scope of the present invention. Therefore, the above drawings and descriptions are illustrative in nature and should not be construed as limiting the scope of the claims.

It should be noted that, in the present invention, relational terms such as first and second, etc., are used solely to distinguish one entity or operation from another, and do not necessarily require or imply any actual relationship or order between these entities or operations. Furthermore, the terms “comprise,” “comprise,” or any other variations thereof are intended to encompass non-exclusive inclusion, such that a process, method, article, or apparatus comprising a list of elements comprises not only those elements but also other elements not expressly listed, or elements inherent to such process, method, article, or apparatus. In the absence of further limitations, an element defined by the phrase “comprising a . . . ” does not preclude the presence of additional identical elements in the process, method, article, or apparatus comprising the element.

The foregoing description is merely a specific embodiment of the present invention, but the scope of protection of the present invention is not limited thereto. Any modifications or substitutions that can be readily conceived by a person skilled in the art within the technical scope disclosed in the present invention are intended to be encompassed by the scope of protection of the present invention. Therefore, the scope of protection of the present invention shall be determined by the scope of protection of the claims.

1. An Intelligent control method for sewage treatment equipment at dry bulk cargo terminals comprising following steps:
various types of sensors are installed at different locations at dry bulk terminals to collect sewage data in real time, preliminary data preprocessing and analysis are performed to obtain initial classifications of sewage types;
historical features and temporal features are extracted from historical data, and the historical and temporal features extracted are combined with preprocessed data to form complete feature vectors for machine learning model input;
models classify based on feature vectors input, output predictive probabilities or classification labels for the sewage types, combining results of rule-based classification and machine learning classification, weighted voting is combined with confidence assessment, so as to obtain final classification results, and operation parameters of sewage treatment equipment are dynamically adjusted based on the final classification results; and
operation and processing information generated after adjusting the operation parameters of the sewage treatment equipment is obtained, sewage treatment status is determined after adjusting the operation parameters according to the final classification results, and controlling the sewage treatment equipment is adjusted and optimized based on treatment results obtained, wherein
the steps that operation and processing information generated after adjusting the operation parameters of the sewage treatment equipment is obtained, sewage treatment status is determined after adjusting the operation parameters according to the final classification results, specifically comprise:
obtaining operation and processing information generated after adjusting the operation parameters of the sewage treatment equipment, wherein the operation and processing information comprises equipment operation information and sedimentation impact information;
the equipment operation information comprises an operation equipment response stability index, and the sedimentation impact information comprises a multi-dimensional sedimentation deviation index;
the operation equipment response stability index and the multi-dimensional sedimentation deviation index are combined to generate an equipment control coefficient;
the operation equipment response stability index is inversely proportional to the equipment control coefficient, while the multi-dimensional sedimentation deviation index is directly proportional to the equipment control coefficient;
the multi-dimensional sedimentation deviation index is used to indicate deviations in sewage sedimentation performance during a sewage treatment process;
the operation equipment response stability index is used to indicate stability and reliability of the sewage treatment equipment's responses during the treatment process;
logic for obtaining the operation equipment response stability index is as follows:
installing sensors and monitoring equipment to monitor equipment adjustment time, operation parameters, and fault occurrences in real time, recording start time and end time of each adjustment operation to obtain adjustment time data, regularly recording datasets of equipment operation, including adjustment time, operation parameters, fault occurrence time, and frequencies, to obtain actual adjustment time Adj_{act} and expected adjustment time Adjₑₓₚ, then calculating standard deviations and means of adjustment time, and calculate adjustment time deviation via following formula:
$$ATD = \vert \frac{{Adj}_{act} - {Adj}_{exp}}{{Adj}_{exp}} \vert ;$$
extracting time points and magnitudes ΔParam when parameters change from the datasets, recording time points when parameters reach a stable state t_{stable} and time points when the parameter changes t_{change}, calculating response time when parameters change
$$PRT = \frac{{t}_{stable} - {t}_{change}}{Δ Param} ,$$
obtaining number of equipment failures F within a time period and total operation time T within the time period;
obtaining standard deviation σ_{adj} and average value μ_{Adj} of adjustment time, calculating stable value of the adjustment time via following calculation expression:
$$ATS = 1 - \frac{{σ}_{Adj}}{{μ}_{Adj}} ,$$
obtaining standard deviation σ_{Par} and average value μ_{Par} of operation parameter deviation, calculating fluctuation value of the operation parameters via following expression:
$$PDS = 1 - \frac{{σ}_{Par}}{{μ}_{Par}} ,$$
and calculating the operation equipment response stability index via following expression:
$$YXS = ATS * PDS * ( 1 - \frac{F}{T} ) * ATD * PRT ;$$
and
logic for obtaining the multi-dimensional sedimentation deviation index is as follows:
obtaining total suspended solids contents TS, volumes of settled sludge|TJ, and interface sedimentation velocities SD in sewage in data samples, obtaining an ideal total suspended solids concentration value, TSᵣₑ, an ideal sludge volume index value TJᵣₑ, and an ideal interface sedimentation velocity value SDᵣₑ, calculating a total suspended solids deviation value via following expression:
$${TS}_{dev} = \frac{TS - {TS}_{re}}{{TS}_{re}} ,$$
establishing a total suspended solids deviation value set
$${TS}_{re}^{i} ,$$
a sludge volume index value set TJᵣₑ, and an interface sedimentation velocity value set
$${SD}_{re}^{i} ,$$
performing standardization processing, and obtaining a total suspended solids deviation standard value via following expression:
$$TSP = \frac{1}{n} * \frac{\sum {TS}_{re}^{i} - min ( {TS}_{re}^{i} )}{max ( {TS}_{re}^{i} ) - min ( {TS}_{re}^{i} )} ,$$
where n represents a total number of the data samples, max represents a function for finding a maximum value, and min represents a function for finding a minimum value; similarly, calculating a sludge volume index standard value TJP and an interface sedimentation velocity standard value SDP, and calculating a multi-dimensional sedimentation deviation index via following expression: DWC=\sqrt{TSP²+TJP²+SDP²}.

2. The Intelligent control method for sewage treatment equipment at dry bulk cargo terminals according to claim 1, wherein the steps that preliminary data preprocessing and analysis are performed to obtain initial classifications of sewage types comprise:
connecting sensors to edge computing nodes, setting data collection frequency and format through the edge computing nodes, and using mean filtering to remove noise from data;
standardizing and converting the data to convert to a uniform unit and scale;
determining preset water quality parameter thresholds based on real-time collected sewage quality parameters, and using the preset water quality parameter thresholds as classification criteria; and
performing preliminary classification based on the preset water quality parameter thresholds, iterating through each of the data samples collected, comparing each water quality parameter against the preset water quality parameter thresholds, performing preliminary classification based on comparison results, and marking classification results for each of the data samples.

3. The Intelligent control method for sewage treatment equipment at dry bulk cargo terminals according to claim 2, wherein the steps that historical features and temporal features are extracted from historical data, and the historical and temporal features extracted are combined with preprocessed data to form complete feature vectors for machine learning model input specifically comprise:
extracting data based on temporal features to determine changes in sewage characteristics over different time periods, adding time tags to each of the data samples, and dividing the data into different time periods based on time of collection;
calculating moving average values and moving standard deviations within time windows of the historical data, and extracting historical features based on calculation results; and
after extracting and constructing the temporal features and the historical features, combining preprocessed real-time data with extracted temporal features and historical features, and incorporating for being input into models, wherein
the models comprise random forests, support vector machines, and neural networks.

4. The Intelligent control method for sewage treatment equipment at dry bulk cargo terminals according to claim 3, wherein the steps that combining results of rule-based classification and machine learning classification, weighted voting is combined with confidence assessment, so as to obtain final classification results, and operation parameters of sewage treatment equipment are dynamically adjusted based on the final classification results, specifically comprise:
according to preset water quality parameter thresholds, performing rule-based classification on the data samples, and assigning one or more sewage types to each of the data samples based on the rule-based classification;
for each of the data samples, performing weighted voting on classification results of machine learning models and results of the rule-based classification, assigning different weights to each classification method based on accuracy thereof;
using the machine learning models to classify the data samples, assessing confidence coefficients of categories based on the rule-based classification, and obtaining an overall confidence coefficient for the categories; and
according to a method of weighted voting combined with confidence assessment, determining final sewage types for each of the data samples, and outputting final classification results for each of the data samples.

5. The Intelligent control method for sewage treatment equipment at dry bulk cargo terminals according to claim 4, wherein the steps that controlling the sewage treatment equipment is adjusted and optimized based on treatment results obtained, specifically comprise:
comparing the generated device control coefficient with an intelligent control threshold;
generating a sewage treatment abnormality signal and adjusting a sewage treatment control plan if the device control coefficient exceeds the intelligent control threshold; and
generating a sewage treatment stable signal and eliminating the need for sewage treatment control and continuing monitoring and maintenance if the device control coefficient is less than or equal to the intelligent control threshold.
